(19) United States
(12) Patent Application Publication
(10) Pub. No.: US 2009/0062990 A1
(43) Pub. Date: Mar. 5, 2009

(54) Systems and Methods for Encouraging the Use of Vehicle Seat Belts

(75) Inventors: William S. Materna, Shelby Township, MI (US); James Y. Khoury, Mocomb, MI (US); Anne F. Ginn, Grosse Pointe, MI (US); Philip R. Horton, Troy, MI (US); Holger Wolf, Essenheim (DE)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/845,802

(22) Filed: Aug. 28, 2007

(51) Int. Cl. B60R 22/48

(52) U.S. Cl. 701/48

(57) ABSTRACT

Seat belt detection systems and methods for encouraging the use of vehicle seat belts are provided. One system includes a driver seat including a seat belt, a seat belt detector coupled to the seat belt, at least one interior component, and a controller in communication with the seat belt detector and the interior component(s), wherein the controller is configured to disable at least one function of the interior component(s) if the seat belt is not fastened. A method includes determining the presence of an occupant in a seat having an associated seat belt, determining whether the seat belt is fastened, and disabling at least one function of an interior component if the seat belt is not fastened.

### FIELD OF THE INVENTION

The present invention generally relates to vehicles, and more particularly relates to systems and methods for encouraging the use of seat belts during operation of vehicles.

### BACKGROUND OF THE INVENTION

For safety reasons, nearly all vehicles (e.g., automobiles, trucks, etc.) include seat belts. However, drivers and/or passengers do not always fasten their respective seat belts during operation of vehicles. Accordingly, it is desirable to provide systems and methods for encouraging drivers and passengers to utilize their respective seat belts during operation of vehicles. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various embodiments provide seat belt detection systems for encouraging the use of vehicle seat belts during operation of a vehicle. One system includes a driver seat including a seat belt, a seat belt detector coupled to the seat belt, at least one interior component, and a controller in communication with the seat belt detector and the interior component(s), wherein the controller is configured to disable at least one function of the interior component(s) if the seat belt is not fastened. Another system includes an occupant seat including a seat belt, a seat belt detector coupled to the seat belt, an occupant detector, an interior component, and a controller in communication with the seat belt detector, the occupant detector, and the interior component, wherein the controller is configured to disable at least one function of the interior component if an occupant is detected and the seat belt is not fastened.

In addition, methods are provided for encouraging the use of vehicle seat belts during operation of a vehicle. One method includes the steps of determining whether a first seat belt associated with a driver seat is fastened and disabling at least one function of an interior component if the first seat belt is not fastened. Another method includes the steps of determining a presence of an occupant in a seat having an associated seat belt, determining whether the seat belt is fastened, and disabling at least one function of an interior component if the seat belt is not fastened.

### BRIEF DESCRIPTION OF THE DRAWINGS

The present invention will hereinafter be described in conjunction with the following drawing figures, wherein like numerals denote like elements, and

FIG. 1 is a diagram of one exemplary embodiment of a system for encouraging the use of vehicle seat belts;

FIG. 2 is a flow diagram representing one embodiment of a method for encouraging the use of vehicle seat belts; and

FIG. 3 is a flow diagram representing another exemplary embodiment of a method for encouraging the use of vehicle seat belts.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

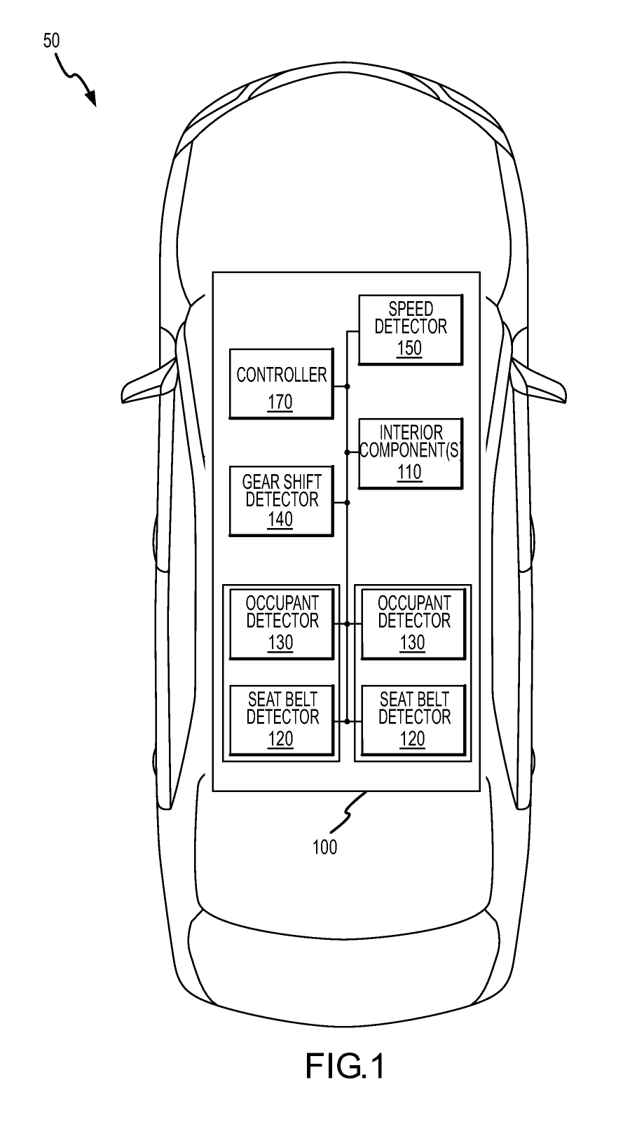

FIG. 1 is a diagram of a vehicle 50 (e.g., an automobile, a truck, etc.) including one exemplary embodiment of a system 100 for encouraging the use of seat belts during operation of vehicle 50. System 100 includes one or more interior components 110 (e.g., navigation systems, cellular telephones, entertainment systems (e.g., radios, CD players, DVD players, MP3 players, etc.), climate controllers, and the like) coupled to a controller 170 that disables (e.g., mutes or “blacks out”) one or more functions of the interior component(s) 110 when at least one occupant does not fasten their respective seat belt.

To detect whether a seat belt has been fastened, system 100 includes at least one seat belt detector 120 in communication with each seat belt and with controller 170. System 100 also includes an occupant detector 130 (e.g., a weight detector, a video camera, a still image camera, an infrared camera, or other device/system capable of detecting an occupant) in communication with controller 170 for detecting the presence of an occupant in a respective seat on a continuous, substantially continuous, or occasional basis.

As is known in the art, vehicle 50 also includes either a manual transmission gear shift actuator or an automatic transmission gear shift actuator to engage operation of vehicle 50. As such, system 100 includes a gear shift detector 140 (e.g., hardware and/or software) in communication with controller 170. Gear shift detector 140 is configured to monitor the gear shift actuator to determine if the vehicle is “in gear” (e.g., in a forward gear or in reverse). Moreover, system 100 includes a speed detector 150 (e.g., hardware and/or software) for determining and transmitting the present rate of speed of vehicle 50 to controller 170.

System 100 also includes a bus 160 (e.g., a wired and/or wireless interface) coupling interior component(s) 110, seat belt detector 120, occupant detector 130, gear shift detector 140, and speed detector 150 to controller 170. Controller 170 includes hardware, software, and/or firmware suitably configured to utilize information received from interior component(s) 110, seat belt detector 120, occupant detector 130, gear shift detector 140, and/or speed detector 150.

Generally, controller 170 is suitably configured to enable and disable one or more functions of at least one interior component 110 based upon the status of one or more seat belts, the gear shift actuator, and/or the rate of speed of vehicle 50. Accordingly, controller 170 is configured to receive a signal from seat belt detector 120 indicating whether the driver has fastened his/her seat belt. If the seat belt is not fastened, controller 170 is configured to disable or mute at least one function of one or more interior components (e.g., the volume of an entertainment system). When the seat belt is fastened, controller 170 enables the at least one function. If at any time during the operation of vehicle 50 the driver's seat belt becomes disengaged, controller 170 is configured to disable the function(s).

Controller 170 is also configured to receive a signal from occupant detector(s) 130 indicating which seat(s) are occupied (e.g., by a driver and/or passenger(s)). Furthermore, controller 170 is configured to receive a signal from seat belt detector(s) 120 indicating which seat belts have been fastened and correlate the signals received from occupant detector 130 and seat belt detector(s) 120 to determine if each person has fastened their respective seat belt. If the seat belt for each respective person has not been fastened, controller 170 is configured to disable or mute at least one function of one or more interior components. When the seat belt for each respective person has been fastened, controller 170 is configured to enable the function(s). Similar to above, if at any time during the operation of vehicle 50 any person's seat belt becomes disengaged controller 170 disables the function(s).

In one embodiment, controller 170 is configured to receive a signal from gear shift detector 140 indicating whether the gear shift actuator has been engaged (i.e., shifted into gear). Controller 170 is also configured to enable the one or more functions of the interior component(s) 110 when the driver and/or each person has not fastened their seat belt if the gear shift actuator has not been engaged (e.g., is in “park” or “neutral” for an automatic transmission, or is in neutral for a manual transmission).

Controller 170, in another embodiment, is configured to receive a signal from speed detector 150 indicating the present rate of speed of vehicle 50. Here, controller 170 is configured to enable the one or more functions of the interior component(s) 110 when the driver and/or each person has not fastened their seat belt if the detected speed is less than a pre-determined threshold speed (e.g., a speed in the range of about 3 miles-per-hours to about 15 miles-per-hour).

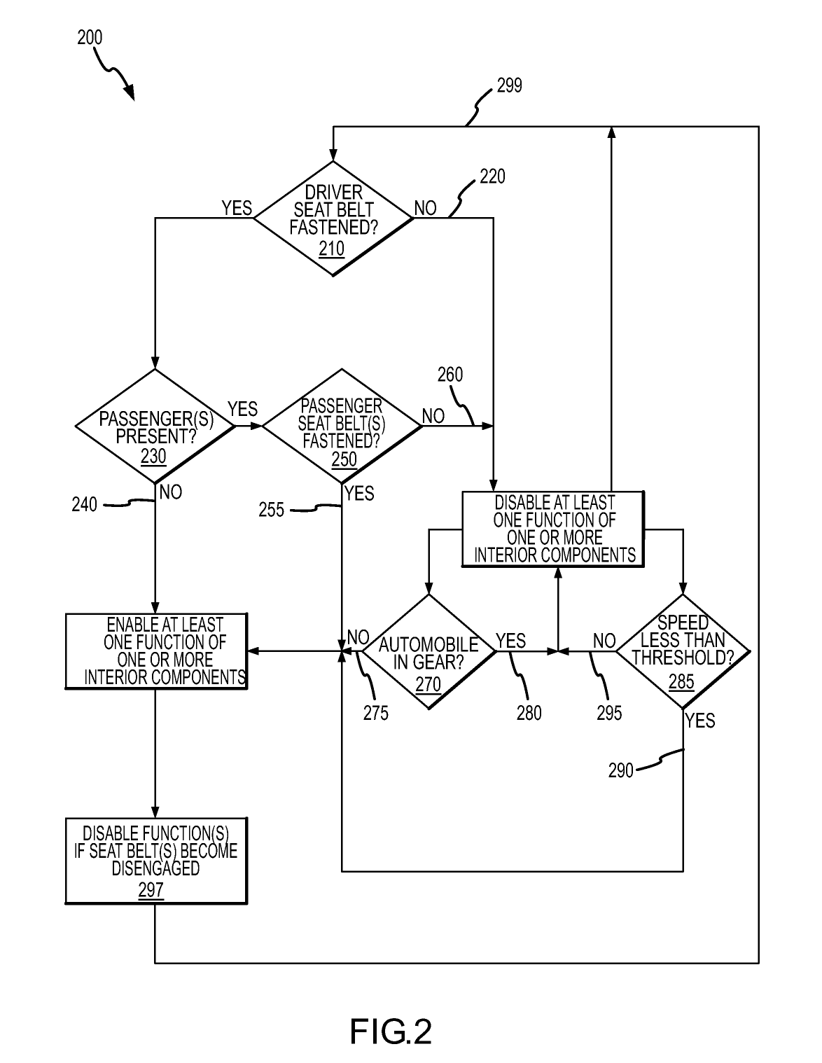

FIG. 2 is a flow diagram representing one embodiment of a method 200 for encouraging the use of seat belts in a vehicle (e.g., vehicle 50). As illustrated in FIG. 2, method 200 begins by determining if a driver's seat belt is fastened (step 210).

If the driver's seat belt is not fastened, at least one function of one or more interior components is disabled or muted (step 220). For example, the display of a navigation system may be “blacked out,” the volume of an entertainment system may become muted, and/or a cellular telephone may become disabled such that telephone calls cannot be initiated and/or received when the driver's seat belt is not fastened.

If the driver's seat belt is fastened, it is determined whether vehicle 50 contains any passengers (step 230). If no passengers are present, one or more functions of an interior component (e.g., an entertainment system, navigation system, cellular telephone, or the like) may be enabled (step 240). When passengers are present, step 250 includes determining if each detected passenger has fastened their respective seat belt.

When seat belts are fastened, the function(s) of the interior component(s) may be enabled (step 255). If the seat belt(s) are not fastened, the function(s) are disabled or muted (step 260).

Method 200 may also include determining if the gear shift actuator of vehicle 50 is “in gear” (step 270). When the gear shift actuator is in not gear, each function of an interior component may be enabled even though the driver's and/or a passenger's seatbelt is not fastened (step 275). If the gear shift actuator is in gear, the function(s) continue to be disabled (step 280).

In addition, method 200 may include determining if the present rate of speed of vehicle 50 is less than a pre-determined threshold speed (step 285). If the present rate of speed is less than the threshold speed (e.g., 5 miles-per-hour), the function(s) of one or more interior components may be enabled even though the driver's and/or a passenger's seatbelt is not fastened (step 290). When the rate of speed is above the threshold speed, the function(s) continue to be disabled (step 295).

Method 200 may also include disabling one or more enabled functions if the driver's and/or a passenger's seat belt becomes disengaged, becomes disengaged and the gear shift actuator is in gear, and/or becomes disengaged and the rate of speed is greater than the threshold speed during operation of vehicle 50 (step 297). Furthermore, method 200 may include repeating one or more of steps 210 through 297 as needed (step 299).

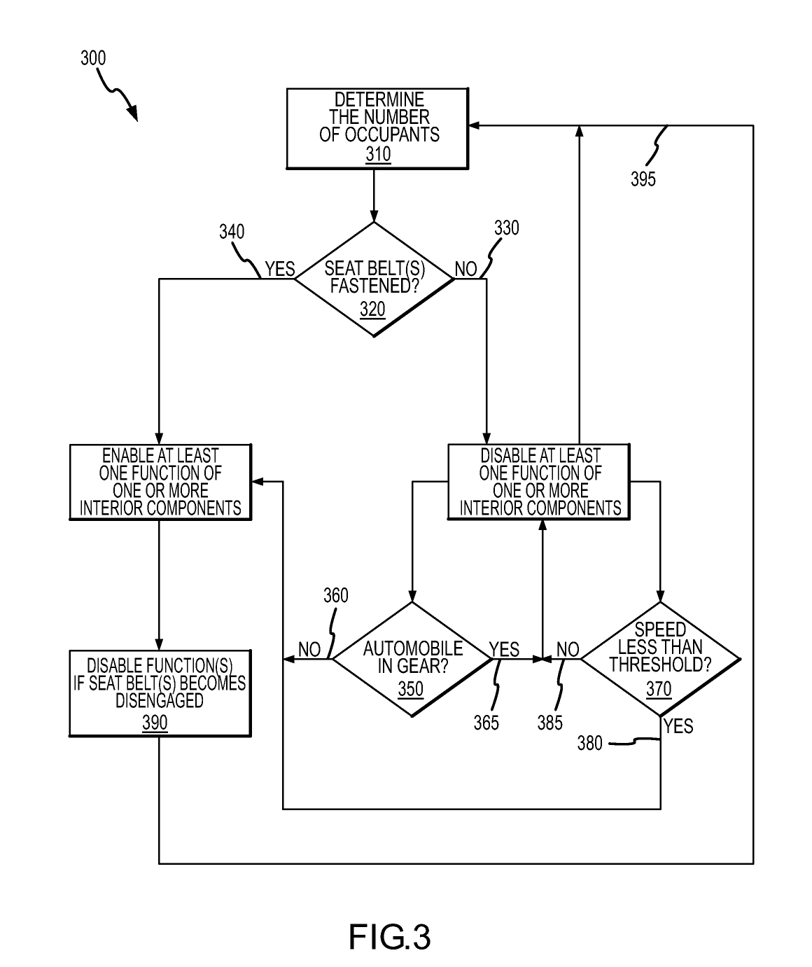

FIG. 3 is a flow diagram representing another exemplary embodiment of a method for encouraging the use of vehicle seat belts. Method 300 begins by determining the number occupants (e.g., driver and/or passenger(s)) present in a vehicle (e.g., vehicle 50) (step 310) and whether each detected occupant has fastened their respective seat belt (step 320).

If at least one seat belt is not fastened, one or more functions of at least one interior component (e.g., an entertainment system, a navigation system, a cellular telephone, or the like) are disabled or muted (step 330). When each seat belt is fastened, the function(s) may be enabled (step 340).

Method 300 may include determining if a gear shift actuator is “in gear” (step 350). If the gear shift actuator is not in gear, the function(s) may be enabled even though each occupant's seatbelt is not fastened (step 360). When the gear shift actuator is in gear, the function(s) continue to be disabled or muted (step 365).

In addition, method 300 may include determining the present rate of speed of vehicle 50 (step 370). When the rate of speed is less than a pre-determined threshold speed (e.g., 5 miles-per-hour), the function(s) may be enabled even though each occupant's seatbelt is not fastened (step 380). If the rate of speed is above the threshold speed, the function(s) continue to be disabled or muted (step 385).

If at least one occupant's seat belt becomes disengaged, becomes disengaged and the gear shift actuator is in gear, and/or becomes disengaged and the rate of speed is greater than the threshold speed, method 300 may include disabling or muting one or more enabled functions (step 390). Moreover, method 300 may include repeating one or more of steps 310 through 390 as needed (step 395).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A seat belt detection system for encouraging the use of vehicle seat belts, the system comprising:
a driver seat including a first seat belt;
a first seat belt detector coupled to the first seat belt;
at least one interior component; and
a controller in communication with the seat belt detector and the at least one interior component, wherein the controller is configured to disable at least one function of the interior component if the first seat belt is not fastened.

2. The system of claim 1, wherein the at least one interior component is one of a navigation system, a cellular telephone, and an entertainment system.

3. The system of claim 1, further comprising:
a second seat belt detector;
at least one passenger seat including a second seat belt in communication with the second seat belt detector; and
a passenger detector in communication with the controller, wherein the controller is further configured to disable the at least one function when a passenger is detected if the second seat belt is not fastened.

4. The system of claim 1, wherein the vehicle includes a gear shift actuator, the system further comprising:
a gear shift detector in communication with the gear shift actuator and with the controller, wherein the controller is further configured to enable the at least one function when the first seat belt is not fastened if the gear shift actuator is not in one of a forward gear and reverse.

5. The system of claim 1, further comprising:
a vehicle speed detector in communication with the controller, wherein the controller is further configured to enable the at least one function when the first seat belt is not fastened if the vehicle is traveling at a rate of speed below a pre-determined threshold speed.

6. A seat belt detection system for encouraging the use of vehicle seat belts, the system comprising:
an occupant seat including a seat belt;
a seat belt detector coupled to the seat belt;
an occupant detector;
an interior component; and
a controller in communication with the seat belt detector, the occupant detector, and the interior component, wherein the controller is configured to disable at least one function of the interior component if an occupant is detected and the seat belt is not fastened.

7. The system of claim 6, wherein the occupant seat is a driver seat and the controller is further configured to enable the at least one function when a driver is not detected.

8. The system of claim 6, wherein the occupant seat is a passenger seat.

9. The system of claim 6, wherein the vehicle includes a gear shift actuator, the system further comprising:
a gear shift detector in communication with the gear shift actuator and with the controller, wherein the controller is further configured to enable the at least one function when the seat belt is not fastened if the gear shift actuator is not in gear.

10. The system of claim 6, further comprising:
a vehicle speed detector in communication with the controller, wherein the controller is further configured to enable the at least one function when the seat belt is not fastened if the vehicle is traveling at a rate of speed below a predetermined threshold speed.

11. A method for encouraging the use of vehicle seat belts during operation of a vehicle, the method comprising the steps of:
determining whether a first seat belt associated with a driver seat is fastened; and
disabling at least one function of an interior component if the first seat belt is not fastened.

12. The method of claim 11, wherein the disabling step comprises the step of muting one of a volume on an entertainment system and a display on a navigation system.

13. The method of claim 11, further comprising the steps of:
detecting a presence of at least one passenger;
determining whether a second seat belt associated with a passenger seat is fastened; and
disabling the at least one function if the second seat belt is not fastened.

14. The method of claim 11, further comprising the steps of:
determining whether a gear shift actuator is in one of a forward gear and a reverse gear; and
enabling the at least one function when the first seat belt is not fastened if the gear shift actuator is not in the one of the forward gear and the reverse gear.

15. The method of claim 11, further comprising the steps of:
detecting a rate of speed the vehicle is traveling; and
enabling the at least one function when the first seat belt is not fastened if the detected speed is below a pre-determined threshold speed.

16. The method of claim 11, further comprising the step of enabling the at least one function if the first seat belt is fastened.

17. A method for encouraging the use of vehicle seat belts during operation of an vehicle, the method comprising the steps of:
determining a presence of an occupant in a seat having an associated seat belt;
determining whether the seat belt is fastened; and
disabling at least one function of an interior component if the seat belt is not fastened.

18. The method of claim 17, wherein the disabling step comprises the step of muting one of a volume on an entertainment system and a display on a navigation system.

19. The method of claim 17, further comprising the steps of:
determining whether a gear shift actuator is in one of a forward gear and a reverse gear; and
enabling the at least one function when the first seat belt is not fastened if the gear shift actuator is not in the one of the forward gear and the reverse gear.

20. The method of claim 17, further comprising the steps of:
detecting a rate of speed the vehicle is traveling; and
enabling the at least one function when the seat belt is not fastened if the detected speed is below a pre-determined threshold speed.

21. The method of claim 17, further comprising the step of enabling the at least one function if the seat belt is fastened.
